(19) United States
(12) Patent Application Publication
(10) Pub. No.: US 2025/0056232 A1
(43) Pub. Date: Feb. 13, 2025

(54) PHONE LICENSE

(71) Applicant: International Business Machines Corporation, Armonk, NY (US)

(72) Inventors: Paritosh RANJAN, Kolkata (IN); Prosanta SAHA, Kolkata (IN); Prodip ROY, Kolkata (IN); Bhubaneswar PADHAN, Kolkata (IN)

(21) Appl. No.: 18/366,798

(22) Filed: Aug. 8, 2023

(51) Int. Cl. H04W 12/12; H04M 1/72463; H04M 15/00

(52) U.S. Cl. CPC H04W 12/12; H04M 1/72463; H04M 15/755

(57) ABSTRACT

A method for validating a phone to perform nonprohibited telecommunication activities. The method includes: determining whether a phone license is configured on a phone; validating that the phone license on the phone is valid; determining whether there are usage prohibitions assigned to the phone license; applying the usage prohibitions to features of the phone; and allowing the phone to perform nonprohibited telecommunication activities.

### BACKGROUND

The present disclosure relates generally to telephone systems, and more specifically, to validate a phone to perform nonprohibited telecommunication activities based on whether a phone license is configured on a phone.

Phone fraud is a billion dollar a year business and includes a phone subscriber attempting to defraud the telephony carriers, telephony carriers attempting to defraud a subscriber, or a third party attempting to defraud either or both of them.

### SUMMARY

According to some embodiments of the disclosure, there is provided a method for validating a phone to perform nonprohibited telecommunication activities. The method includes: determining whether a phone license is configured on a phone; validating that the phone license on the phone is valid; determining whether there are usage prohibitions assigned to the phone license; applying the usage prohibitions to features of the phone; and allowing the phone to perform nonprohibited telecommunication activities.

According to some embodiments of the disclosure, there is provided a computer program product for validating a phone to perform nonprohibited telecommunication activities. The computer program product includes one or more computer-readable storage media; and program instructions, stored on at least one of the one or more storage media, to: determine whether a phone license is configured on the phone; validate that the phone license on the phone is valid; determine whether there are usage prohibitions assigned to the phone license; apply the usage prohibitions to features of the phone; and allow the phone to perform nonprohibited telecommunication activities.

According to some embodiments of the disclosure, there is provided a computer system for validating a phone to perform nonprohibited telecommunication activities. The computer system includes: a phone; one or more processors, one or more computer-readable memories and one or more computer-readable storage media; program instructions, stored on at least one of the one or more storage media for execution by at least one of the one or more processors via at least one of the one or more memories, to determine whether a phone license is configured on the phone; program instructions, stored on at least one of the one or more storage media for execution by at least one of the one or more processors via at least one of the one or more memories, to validate that the phone license on the phone is valid; program instructions, stored on at least one of the one or more storage media for execution by at least one of the one or more processors via at least one of the one or more memories, to determine whether there are any usage prohibitions assigned to the phone license; program instructions, stored on at least one of the one or more storage media for execution by at least one of the one or more processors via at least one of the one or more memories, to apply the usage prohibitions to features of the phone; and program instructions, stored on at least one of the one or more storage media for execution by at least one of the one or more processors via at least one of the one or more memories, to allow the phone to perform nonprohibited telecommunication activities.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 illustrates a telephone system, in accordance with some embodiments.

FIG. 2 is a flowchart showing a method, in accordance with some embodiments of the disclosure.

FIG. 3 illustrates a phone including a screen with a first display, in accordance with some embodiments of the disclosure.

FIG. 4 illustrates the phone of FIG. 3 including the screen with a second display, in accordance with some embodiments of the disclosure.

FIG. 5 illustrates the phone of FIG. 4 including the screen with a third display, in accordance with some embodiments of the disclosure.

FIG. 6 illustrates the phone of FIG. 5 including the screen with a fourth display, in accordance with some embodiments of the disclosure.

FIG. 7 is a block diagram view of a system, in accordance with some embodiments.

While the disclosure is amenable to various modifications and alternative forms, specifics thereof have been shown by way of example in the drawings and will be described in detail. It should be understood, however, that the intention is not to limit the disclosure to the particular embodiments described. On the contrary, the intention is to cover all modifications, equivalents, and alternatives falling within the spirit and scope of the disclosure.

### DETAILED DESCRIPTION

Aspects of the present disclosure relate to telephone systems, and more specifically, to validate a phone to perform nonprohibited telecommunication activities based on whether a phone license is configured on a phone.

When any phone user changes its phone number, there is no way to know about the user's past telecommunication (otherwise known as “telecom”) behavior with its previous phone numbers. For example, there is no way to know: how many spam call or message complaints were made against the user of the user's previous phone numbers; and/or, how many spam call or message penalties were applied against the user for the user's previous phone numbers.

Based on telecom behavior of any user, a telecom regulatory authority might want to limit or suspend the user from using certain telecom services for a specific period as penalty, e.g., an hour, a day, a week, a month, a year, etc. For example: a) if ten (10) spam call complaints were made against the user within a day, then the authority can limit the user's calling ability to a maximum one (1) call per hour; b) if twenty (20) spam call complaints were made against the user within a day, then the authority can suspend the user's calling ability for one (1) day; c) if ten (10) spam message complaints were made against the user within a day, then limit the user's message sending capability to one (1) message per fifteen (15) minutes; and, d) if one hundred (100) spam message complaints were made against the user within a day, then the authority can suspend the user's message sending capability for one (1) week.

In current telephone systems, even if the user's current phone number is blocked, the user can still purchase a subscriber identity module (SIM) card with a new phone number and can start making spam calls from that number. So, technically, it may not be possible to stop any “spammer” from spam calling if the caller changes its phone number or telecom provider. If the user changes its phone number or telecom provider, then there may be no way to identify previous telecom behavior of the user and to execute the penalty currently applied on the user's calling discipline.

Embodiments of the disclosure includes a system and/or method including enforcing and validating a phone license on a phone. The system and/or method also include applying restrictions, suspensions, and/or other policies in the form of telecom actions, limitations and/or suspensions on or to the phone assigned with the phone license. The system and/or method can assign restrictions, suspensions, and/or other policies/penalties on the phone license. The “restrictions, suspensions, and/or other policies” can be defined or indicated herein as “usage prohibitions,” and is a singular term that can cover all three situations.

The phone license disclosed herein can be defined as a permission or permit to use a phone and/or a phone number according to restrictions, suspensions, and/or other policies that can be applied or assigned to telecom actions relating to or allowed on the phone and/or the phone number. The phone license disclosed herein is analogous to a driver's license, for example. A valid driver's license is needed by a driver in order to drive a vehicle. If a driver's license of a driver is cancelled or revoked after violating a law, for example, while driving one vehicle, then the driver is also prohibited from driving other vehicles and not just that one vehicle.

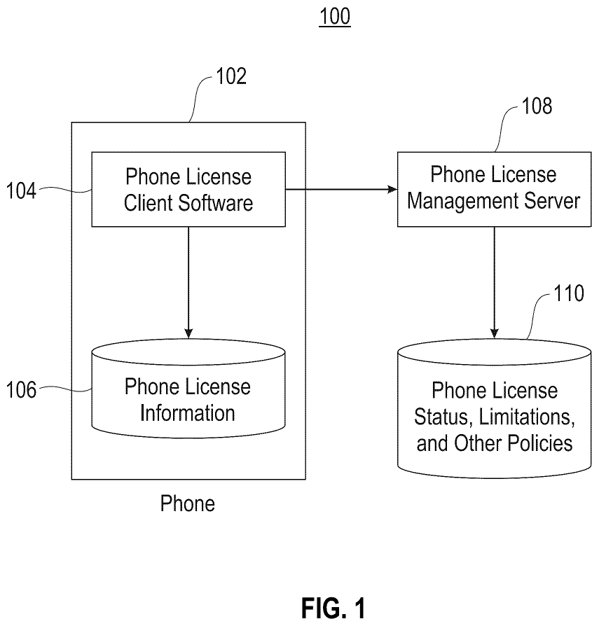

Turning to the figures, FIG. 1 is a telephone system 100, in accordance with embodiments of the disclosure. The telephone system 100 includes a telephone 102 (or “phone”). The phone 102 can be any type of telephone including, but not limited to, a mobile phone or a smart phone. The phone 102 can include a software component, known as a phone license client software 104 that can be installed on the phone 102. The phone license client software 104 can check the phone 102 for a valid phone license that can be configured on the phone 102. The phone license client software 104 can search for the phone license information on a disk, which can be a hard disk memory, local storage on a phone, etc., for example.

The phone 102 can also include phone license information 106. At the time of a bootup request of the phone 102, for example, the phone license client software 104 can check for a valid phone license that may be configured on the phone 102. The phone license client software 104 can search the phone license information 106 on the phone 102. The phone license information 106 can include information about limitations and/or suspensions currently active on the phone license. If a valid phone license is found on the phone 102, then the phone 102 can bootup normally and can be ready for use. If a valid phone license is not found on the phone 102, then a user may be asked to enter a valid phone license identifier on the phone 102 because the phone 102 will not function without a valid phone license. If the user does enter a phone license identifier into the phone 102, the phone license client software 104 can also ask the user to authenticate the entered phone license.

The phone license client software 104 on the phone 102 can access a phone license management server 108 via the internet. The phone 102 can be equipped with a SIM card that has network or internet access in order for phone license validation to occur. The phone license client software 104 on the phone 102 can query the phone license management server 108 to validate or authenticate the phone license information 106 on the phone 102. The phone license management server 108 can also access phone license status, limitations, and other policies 110 via a query to the phone license management server via representational state transfer (REST) application programming interfaces (APIs) to fetch and store the fetched policies locally on the phone in memorably/local disk storage, for example. The phone license management server can store the policies against a phone license on a database, for example. The policies 110 that can be retrieved for the phone license can contain information about the limitations and suspensions, for example, which are currently active on the phone license. The phone license client software 104 on the phone 102 can monitor and restrict features of the phone 102 as per the policies 110 retrieved from the phone license.

If the phone license authentication process is unsuccessful, then the phone 102 would not work, and the phone license client software 104 would keep asking the user for a valid phone license to be provided. If the phone license authentication is successful, then the phone 102 would bootup and the phone license client software 104 would fetch policies, for example, that applied to the phone license from the phone license management server 108.

If a phone network, the internet, for example, is available, then the phone license client software 104 can periodically, e.g., every fifteen (15) minutes, keep checking the phone status and the phone license's limitations and suspensions 110. If the phone license is found suspended/invalid/expired, etc., then the phone license client software 104 can block phone usage and can ask the user to provide a valid phone license. If any limitations or suspensions 110 of phone features are found for the phone license, then the feature limitation or suspension 110 can be monitored and applied by the phone license client software 104. Any limitation, suspension or restriction 110 can be applied by an administrator or controlling authority to the phone license in the phone license management server 108 via application programming interface (API) or user interface (UI), for example.

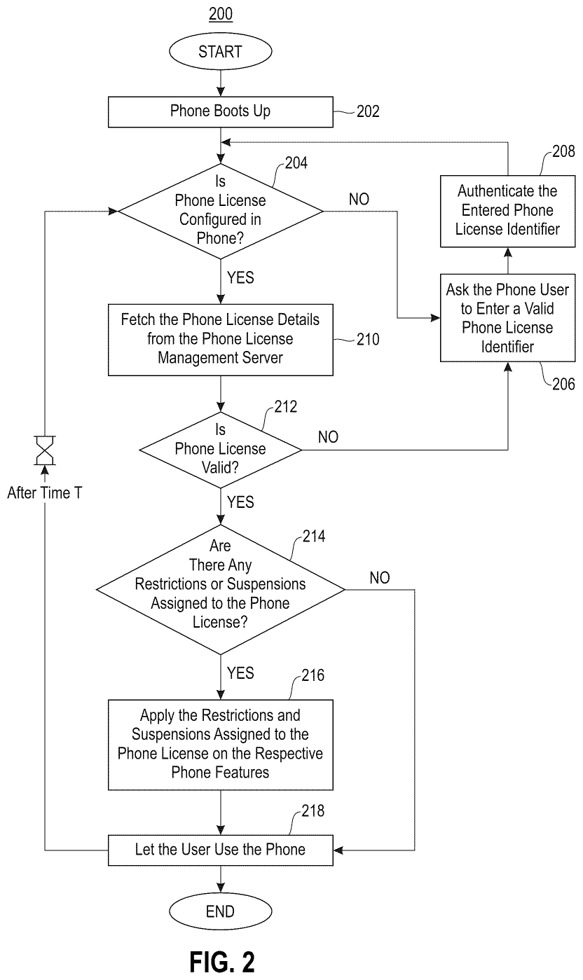

FIG. 2 is a flowchart showing a method 200, in accordance with some embodiments of the disclosure. An operation 202 of the method 200 is turning on or booting up a phone 102 (as shown in FIG. 1). At the time of the bootup, phone license client software 104 (as shown in FIG. 1) can check for presence of a valid phone license being configured on the phone 102. The phone license client software 104 can search for phone license information 106 (as shown in FIG. 1) on a disk, and/or can query a phone license management server 108 (as shown in FIG. 1) to validate the phone license information 106.

Another operation 204 of the method 200 is determining whether the phone license is configured on the phone 102. If the determination from operation 204 is that no phone license is configured on the phone 102, then another operation 206 can be to ask a user of the phone to enter or provide a valid phone license. The phone 102 would not function without a valid phone license. In yet another operation 208, authentication of the phone license entered by the user can be performed. Authentication can be requested from phone license client software 104. If the determination from the operation 204 is that a phone license is configured on the phone 102, then details of the phone license can be fetched from, or found in, the phone license management server 108, according to operation 210. Operation 212 is a query to determine whether the phone license is valid. If a valid phone license is not found, then the user can be asked again to enter a valid phone license, as in the operation 206. If a valid phone license is found and entered, then the phone 102 can boot up normally and will be ready to use.

The user can enter or provide the phone license identifier in any suitable way. For example, the phone license identifier can be entered manually, such as by entering a number, a series of numbers and letters, or some other code. Another example of entering a phone license can be to enter the phone license identifier by scanning a quick response (QR) code. Yet another example of how to enter a phone license identifier can be by scanning a phone license card, such as by using optical character recognition (OCR), for example, and reading the phone license identifier from the phone license card.

The phone license client software 104 can request the user to authenticate an entered phone license identifier in any suitable way. Some examples of ways to authenticate an entered phone license identifier include, but are not limited to: biometric authentication, user name/password, one-time password (OTP) on an email identification (ID) linked with the phone license, or OTP on a mobile number linked with the phone license. The phone license client software 104 can query the phone license management server 108 over the internet to authenticate the phone license user. The phone 102 can be equipped with a SIM card with network access in order for phone license validation to occur. If the phone license authentication is unsuccessful, then the phone 102 will not work, and the phone license client software 104 can keep asking for a valid phone license identifier to be provided. If the phone license authentication is successful, then the phone 102 will boot up and the phone license client software 104 can fetch policies 110 (as shown in FIG. 1) applied to the phone license from the phone license management server 108.

After a valid phone license is found (as in operation 212), a query can be made, at operation 214, as to whether there are any restrictions, policies, and/or suspensions, etc. assigned to the phone license. If any restrictions, policies, and/or suspensions, etc., are found assigned to the phone license, then at operation 216, the restriction, policy or suspension, etc. is/are applied on certain, respective phone features. After any restriction, policy or suspension, etc., is applied, then the user of the phone 102 can be allowed to use the phone 102, as in operation 218. If no restrictions, policies, and/or suspensions, etc., are found assigned to the phone license, then the user can also be allowed to use the phone, as in operation 218. Once the user is allowed to use the phone 102, after a given time (T), the method can return to operation 204, and can query if a phone license is configured on the phone 102. The phone license client software 104 can periodically check the phone license status and the phone license's restriction, policy and/or suspensions, etc.

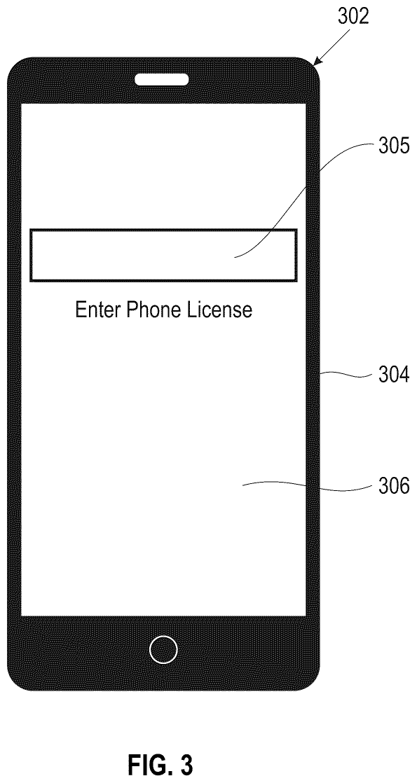

FIG. 3 illustrates a phone 302 including a screen 304 with a first display 306, in accordance with some embodiments of the disclosure. As shown, the first display 306 on the screen 304 of the phone 302 requests a phone license identifier to be entered by a user using a command “Enter Phone License” that appears in the first display 306 (e.g., in operation 206 of FIG. 2). A box 305 where the phone license identifier can be entered by the user also appears in the first display 306.

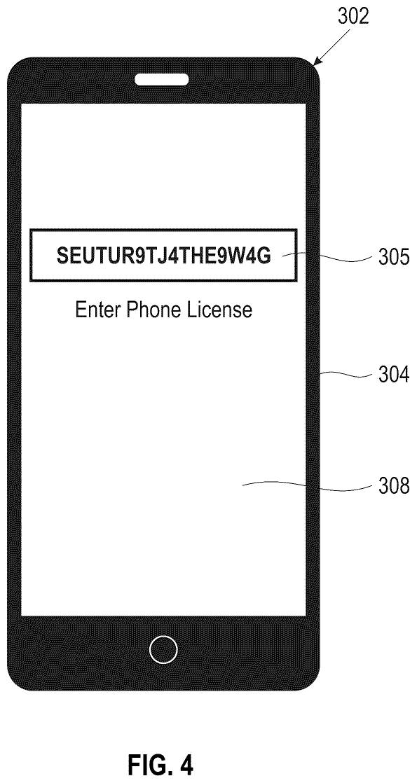

FIG. 4 illustrates the phone 302 of FIG. 3 including the screen 304 with a second display 308, in accordance with some embodiments of the disclosure. As shown, the second display 308 includes the phone license identifier appearing in the box 305. The phone license identifier shown is a series of letters and numbers, as an example.

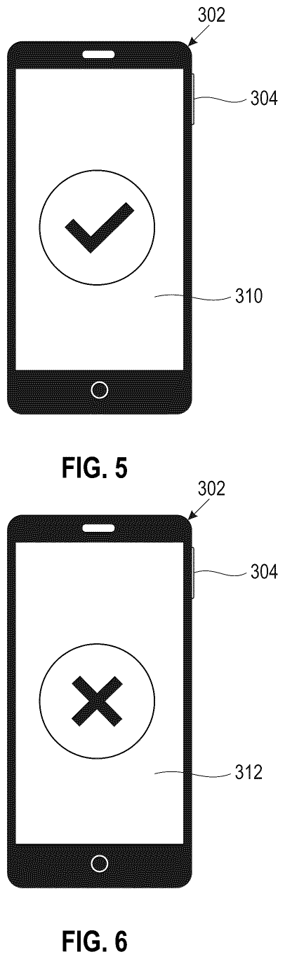

FIG. 5 illustrates the phone 302 of FIG. 4 including the screen 304 with a third display 310, in accordance with some embodiments of the disclosure. As shown, the third display 310 includes a check mark, which indicates that a valid phone license was detected (e.g., after operation 212 in FIG. 2). FIG. 6 illustrates the phone 302 of FIG. 5 including the screen 304 with a fourth display 312, in accordance with some embodiments of the disclosure. As shown, the fourth display 312 includes an “x,” which indicates that an invalid phone license was detected (e.g., after operation 212 in FIG. 2). The checkmark and the “x” are examples of displays in response to valid or invalid phone licenses being entered into the phone 302. Other suitable messages, etc., can be used to indicate that the phone license entered was either valid or invalid.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

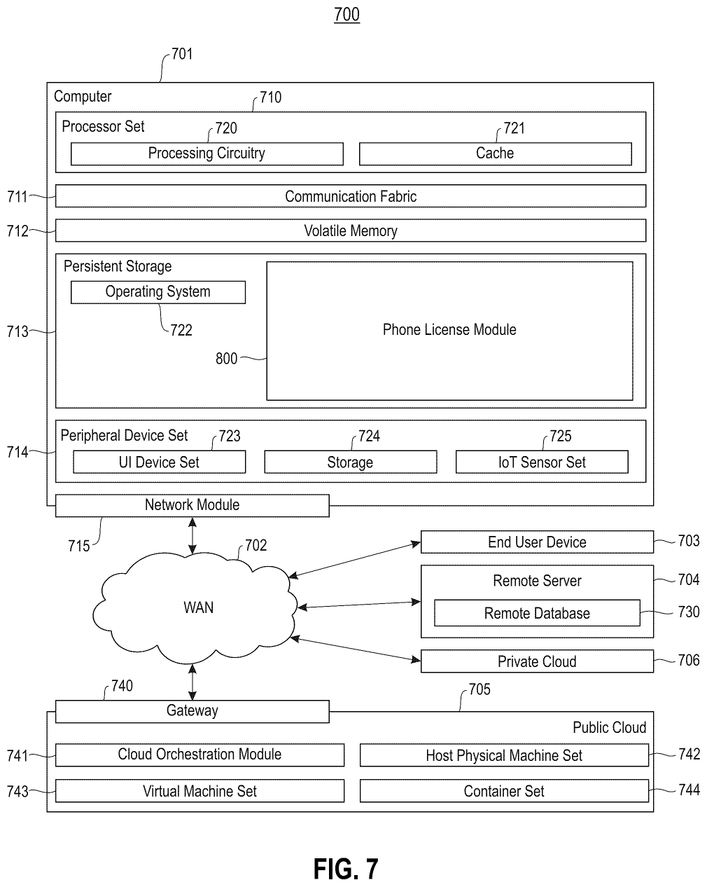

As in FIG. 7, computing environment 700 contains an example of an environment for the execution of at least some of the computer code involved in performing the disclosed methods, such as phone license module 800. In addition to block 800, computing environment 700 includes, for example, computer 701, wide area network (WAN) 702, end user device (EUD) 703, remote server 704, public cloud 705, and private cloud 706. In this embodiment, computer 701 includes processor set 710 (including processing circuitry 720 and cache 721), communication fabric 711, volatile memory 712, persistent storage 713 (including operating system 722 and block 800, as identified above), peripheral device set 714 (including user interface (UI) device set 723, storage 724, and Internet of Things (IoT) sensor set 725), and network module 715. Remote server 704 includes remote database 730. Public cloud 705 includes gateway 740, cloud orchestration module 741, host physical machine set 742, virtual machine set 743, and container set 744.

Computer 701 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 730. As is well understood in the art of computer technology, and depending upon the technology, performance of a computer-implemented method may be distributed among multiple computers and/or between multiple locations. On the other hand, in this presentation of computing environment 700, detailed discussion is focused on a single computer, specifically computer 701, to keep the presentation as simple as possible. Computer 701 may be located in a cloud, even though it is not shown in a cloud in FIG. 7. On the other hand, computer 701 is not required to be in a cloud except to any extent as may be affirmatively indicated.

Processor set 710 includes one, or more, computer processors of any type now known or to be developed in the future. Processing circuitry 720 may be distributed over multiple packages, for example, multiple, coordinated integrated circuit chips. Processing circuitry 720 may implement multiple processor threads and/or multiple processor cores. Cache 721 is memory that is located in the processor chip package(s) and is typically used for data or code that should be available for rapid access by the threads or cores running on processor set 710. Cache memories are typically organized into multiple levels depending upon relative proximity to the processing circuitry. Alternatively, some, or all, of the cache for the processor set may be located “off chip.” In some computing environments, processor set 710 may be designed for working with qubits and performing quantum computing.

Computer readable program instructions are typically loaded onto computer 701 to cause a series of operational steps to be performed by processor set 710 of computer 701 and thereby effect a computer-implemented method, such that the instructions thus executed will instantiate the methods specified in flowcharts and/or narrative descriptions of computer-implemented methods included in this document (collectively referred to as “the disclosed methods”). These computer readable program instructions are stored in various types of computer readable storage media, such as cache 721 and the other storage media discussed below. The program instructions, and associated data, are accessed by processor set 710 to control and direct performance of the disclosed methods. In computing environment 700, at least some of the instructions for performing the disclosed methods may be stored in block 800 in persistent storage 713.

Communication fabric 711 is the signal conduction path that allows the various components of computer 701 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 712 is any type of volatile memory now known or to be developed in the future. Examples include dynamic type random access memory (RAM) or static type RAM. Typically, volatile memory 712 is characterized by random access, but this is not required unless affirmatively indicated. In computer 701, the volatile memory 712 is located in a single package and is internal to computer 701, but, alternatively or additionally, the volatile memory may be distributed over multiple packages and/or located externally with respect to computer 701.

Persistent storage 713 is any form of non-volatile storage for computers that is now known or to be developed in the future. The non-volatility of this storage means that the stored data is maintained regardless of whether power is being supplied to computer 701 and/or directly to persistent storage 713. Persistent storage 713 may be a read only memory (ROM), but typically at least a portion of the persistent storage allows writing of data, deletion of data and re-writing of data. Some familiar forms of persistent storage include magnetic disks and solid-state storage devices. Operating system 722 may take several forms, such as various known proprietary operating systems or open-source Portable Operating System Interface-type operating systems that employ a kernel. The code included in block 800 typically includes at least some of the computer code involved in performing the disclosed methods.

Peripheral device set 714 includes the set of peripheral devices of computer 701. Data communication connections between the peripheral devices and the other components of computer 701 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 723 may include components such as a display screen, speaker, microphone, wearable devices (such as goggles and smart watches), keyboard, mouse, printer, touchpad, game controllers, and haptic devices. Storage 724 is external storage, such as an external hard drive, or insertable storage, such as an SD card. Storage 724 may be persistent and/or volatile. In some embodiments, storage 724 may take the form of a quantum computing storage device for storing data in the form of qubits. In embodiments where computer 701 is required to have a large amount of storage (for example, where computer 701 locally stores and manages a large database) then this storage may be provided by peripheral storage devices designed for storing very large amounts of data, such as a storage area network (SAN) that is shared by multiple, geographically distributed computers. IoT sensor set 725 is made up of sensors that can be used in Internet of Things applications. For example, one sensor may be a thermometer and another sensor may be a motion detector.

Network module 715 is the collection of computer software, hardware, and firmware that allows computer 701 to communicate with other computers through WAN 702. Network module 715 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 715 are performed on the same physical hardware device. In other embodiments (for example, embodiments that utilize software-defined networking (SDN)), the control functions and the forwarding functions of network module 715 are performed on physically separate devices, such that the control functions manage several different network hardware devices. Computer readable program instructions for performing the disclosed methods can typically be downloaded to computer 701 from an external computer or external storage device through a network adapter card or network interface included in network module 715.

WAN 702 is any wide area network (for example, the internet) capable of communicating computer data over non-local distances by any technology for communicating computer data, now known or to be developed in the future. In some embodiments, the WAN 702 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 703 is any computer system that is used and controlled by an end user (for example, a customer of an enterprise that operates computer 701) and may take any of the forms discussed above in connection with computer 701. EUD 703 typically receives helpful and useful data from the operations of computer 701. For example, in a hypothetical case where computer 701 is designed to provide a recommendation to an end user, this recommendation would typically be communicated from network module 715 of computer 701 through WAN 702 to EUD 703. In this way, EUD 703 can display, or otherwise present, the recommendation to an end user. In some embodiments, EUD 703 may be a client device, such as thin client, heavy client, mainframe computer, desktop computer and so on.

Remote server 704 is any computer system that serves at least some data and/or functionality to computer 701. Remote server 704 may be controlled and used by the same entity that operates computer 701. Remote server 704 represents the machine(s) that collect and store helpful and useful data for use by other computers, such as computer 701. For example, in a hypothetical case where computer 701 is designed and programmed to provide a recommendation based on historical data, then this historical data may be provided to computer 701 from remote database 730 of remote server 704.

Public cloud 705 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 705 is performed by the computer hardware and/or software of cloud orchestration module 741. The computing resources provided by public cloud 705 are typically implemented by virtual computing environments that run on various computers making up the computers of host physical machine set 742, which is the universe of physical computers in and/or available to public cloud 705. The virtual computing environments (VCEs) typically take the form of virtual machines from virtual machine set 743 and/or containers from container set 744. It is understood that these VCEs may be stored as images and may be transferred among and between the various physical machine hosts, either as images or after instantiation of the VCE. Cloud orchestration module 741 manages the transfer and storage of images, deploys new instantiations of VCEs and manages active instantiations of VCE deployments. Gateway 740 is the collection of computer software, hardware, and firmware that allows public cloud 705 to communicate through WAN 702.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 706 is similar to public cloud 705, except that the computing resources are only available for use by a single enterprise. While private cloud 706 is depicted as being in communication with WAN 702, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 705 and private cloud 706 are both part of a larger hybrid cloud.

As used in this application and in the claims, the singular forms “a,” “an,” and “the” include the plural forms unless the context clearly dictates otherwise. Additionally, the term “includes” means “comprises.”

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A method for validating a phone to perform nonprohibited telecommunication activities, comprising the steps of:
determining whether a phone license is configured on a phone;
validating that the phone license on the phone is valid;
determining whether there are usage prohibitions assigned to the phone license;
applying the usage prohibitions to features of the phone; and
allowing the phone to perform nonprohibited telecommunication activities.

2. The method of claim 1, further comprising:
requesting a user of the phone to provide an identifier of the phone license to the phone.

3. The method of claim 2, further comprising:
authenticating the provided phone license identifier.

4. The method of claim 2, wherein the identifier of the phone license can include a series of numbers and/or letters.

5. The method of claim 2, wherein the identifier of the phone license is a quick response (QR) code.

6. The method of claim 2, wherein the identifier of the phone license is on a phone license card.

7. The method of claim 1, further comprising:
booting up the phone prior to determining whether a phone license is configured on the phone.

8. A computer program product for validating a phone to perform nonprohibited telecommunication activities, the computer program product comprising:
one or more computer-readable storage media; and
program instructions, stored on at least one of the one or more storage media, to:
determine whether a phone license is configured on the phone;
validate that the phone license on the phone is valid;
determine whether there are usage prohibitions assigned to the phone license;
apply the usage prohibitions to features of the phone; and
allow the phone to perform nonprohibited telecommunication activities.

9. The computer program product of claim 8, wherein the program instructions, stored on at least one of the one or more storage media, request a user of the phone to provide an identifier of the phone license to the phone.

10. The computer program product of claim 9, wherein the program instructions, stored on at least one of the one or more storage media, authenticate the provided phone license identifier.

11. The computer program product of claim 9, wherein the identifier of the phone license can include a series of numbers and/or letters.

12. The computer program product of claim 9, wherein the identifier of the phone license is a quick response (QR) code.

13. The computer program product of claim 9, wherein the identifier of the phone license is on a phone license card.

14. A computer system for validating a phone to perform nonprohibited telecommunication activities, the computer system comprising:
a phone;
one or more processors, one or more computer-readable memories and one or more computer-readable storage media;
program instructions, stored on at least one of the one or more storage media for execution by at least one of the one or more processors via at least one of the one or more memories, to determine whether a phone license is configured on the phone;
program instructions, stored on at least one of the one or more storage media for execution by at least one of the one or more processors via at least one of the one or more memories, to validate that the phone license on the phone is valid;
program instructions, stored on at least one of the one or more storage media for execution by at least one of the one or more processors via at least one of the one or more memories, to determine whether there are any usage prohibitions assigned to the phone license;
program instructions, stored on at least one of the one or more storage media for execution by at least one of the one or more processors via at least one of the one or more memories, to apply the usage prohibitions to features of the phone; and
program instructions, stored on at least one of the one or more storage media for execution by at least one of the one or more processors via at least one of the one or more memories, to allow the phone to perform nonprohibited telecommunication activities.

15. The computer system of claim 14, further comprising:
program instructions, stored on at least one of the one or more storage media for execution by at least one of the one or more processors via at least one of the one or more memories, to request a user of the phone to provide an identifier of the phone license to the phone.

16. The computer system of claim 15, further comprising:
program instructions, stored on at least one of the one or more storage media for execution by at least one of the one or more processors via at least one of the one or more memories, to authenticate the provided phone license identifier.

17. The computer system of claim 15, wherein the identifier of the phone license can include a series of numbers and/or letters.

18. The computer system of claim 15, wherein the identifier of the phone license is a quick response (QR) code.

19. The computer system of claim 15, wherein the identifier of the phone license is on a phone license card.

20. The computer system of claim 14, further comprising:
program instructions, stored on at least one of the one or more storage media for execution by at least one of the one or more processors via at least one of the one or more memories, to boot up the phone after validating the phone license.
